(19) United States
(12) Patent Application Publication
(10) Pub. No.: US 2016/0369782 A1
(43) Pub. Date: Dec. 22, 2016

(54) APPARATUS FOR SIMULTANEOUSLY SUPPLYING HETEROGENEOUS LUBRICANTS APPLIED TO ALL BEARINGS AND ALL DRIVERS OF WIND GENERATOR, AND LUBRICANT SUPPLY AND RECOVERY APPARATUS OF BEARING

(71) Applicant: AHWON CORPORATION, Gunpo-si (KR)

(72) Inventor: JUHO LEE, Gunpo-si (KR)

(21) Appl. No.: 15/039,838

(22) PCT Filed: Dec. 22, 2014
(86) PCT No.: PCT/KR2014/012648

§ 371 Date: May 26, 2016

(30) Foreign Application Priority Data
Dec. 23, 2013 (KR) 10-2013-0161133

(51) Int. Cl. F03D 80/70; F16N 31/00; F16N 23/00; F16N 7/38; F16N 19/00

(52) U.S. Cl. CPC F03D 80/70; F16N 7/385; F16N 19/003; F16N 23/00; F16N 31/00; F05B 2260/98; F05B 2240/50; F05B 2220/30; F16N 2210/025; F16N 2250/18; F16N 2270/70; F16N 2280/02

(57) ABSTRACT

The present invention including an apparatus for simultaneously supplying heterogeneous lubricants applied to all bearings and drivers of a wind generator, the lubricant supply apparatus (100) comprises: a bearing pump unit (110) which is filled with a lubricant applied to a pitch bearing or a yaw bearing; a driver pump unit (120) which is filled with a lubricant applied to a pitch driver or a yaw driver; a drive part housing (130) for receiving a motor (131) and receiving a cam (132) inserted in the shaft of the motor (131); a supply pump unit (140) driven by being asymmetrically coupled to the cam (132); a bearing supply line (150), provided at the lower portion of the bearing pump unit (110), for filling the bearing pump unit (110) with the lubricant pumped by the supply pump unit (140) and supplying the lubricant filled in the bearing pump unit (110) to the pitch bearing or the yaw bearing.

### CROSS-REFERENCE TO RELATED APPLICATION

This application claims the benefit of Korean Application No. 10-2013-0161133, filed on Dec. 23, 2013 with the Korean Intellectual Property Office, the disclosure of which is incorporated herein by reference.

### TECHNICAL FIELD

The present invention relates to an apparatus for simultaneously supplying heterogeneous lubricants applied to all bearings and drivers of a wind generator, and a lubricant supply and recovery apparatus of a bearing, and more particularly, to an apparatus for simultaneously supplying heterogeneous lubricants applied to all bearings and drivers of a wind generator, and a lubricant supply and recovery apparatus of a bearing, in which lubricants applied to pitch and yaw bearings and lubricants applied to pitch and yaw drivers are combined in one lubricant supplier such that the installation space and the economic costs can be significantly reduced, lubricants applied to the pitch bearing or the yaw bearing and a main bearing can be supplied, and the supplied lubricants can be recovered.

### BACKGROUND ART

In general, a wind generator is a system to convert kinetic energy generated by the flow of air into mechanical energy by rotating a blade using the aerodynamic characteristic, and to obtain electrical energy by rotating a power generator using the mechanical energy.

The typical structure of a wind generator 1, which has attracted attention as a new renewable energy generator, is shown in FIG. 1.

Referring to FIG. 1, the wind generator 1 includes a tower 2 fixedly installed at a proper height from the ground surface and a nacelle 3 provided on an upper end of the tower 2, and the nacelle 3 is provided therein with a generator 4, a gear box 5, and a main shaft 6. A plurality of blades 9 are installed on a hub 8 in a rotor 7 rotating by the force of wind.

In addition, a yaw bearing 10 and a yaw driver (not shown), which is rotated about the tower 2 by a driving device of a motor, are provided at the contact position between the tower 2 and the nacelle 3. There are installed a generator bearing (not shown) provided in the wind generator, main bearings 6a provided at front and rear portions of a main shaft 6, a pitch bearing 9a provided at an end portion of the blade 9, and a pitch driver (not shown) to drive the pitch bearing 9a through the driving device of the motor.

According to the above configuration, the kinetic energy of the air is received in the blade 9 so that the rotor 7 is rotated. In this case, the kinetic energy is maximized at a speed increaser (not shown) received in a gear box 5 through the main shaft 6.

Thereafter, the electric energy is generated through a power generator 4, and charged in a power storage device or directly supplied to a consumer.

When the wind generator 1 is operated for a long time as described above, parts, in which friction frequently occurs, that is, the yaw bearing 10, the yaw driver, the generator bearing, the main bearing 6a, the pitch bearing 9a, and the pitch driver must be supplied with lubricant for smooth driving, and the supplied lubricant must be recovered to prevent environment contamination.

A lubricant supply and recovery device 20 includes a pump assembly 21, a feeding line 21, and a recovered oil storage unit 23 as shown in FIG. 2.

As shown in FIG. 3, the pump assembly 21 includes a pump casing part 30 including a piston cam receiving part 31 and a supply piston cam part 32 at a lower portion thereof, and a driving part 40 including a motor 41 and a driving shaft 42.

However, since the lubricant supply and recovery device 20 is configured to supply one type of lubricant, the lubricant supply and recovery device 20 has the following problem.

In other words, since the lubricant supplied to the yaw bearing 10 and the pitch bearing 9a is different from that supplied to the yaw driver and the pitch driver, the six lubricant supply and recovery devices 20 must be installed for the pitch bearing 9a, the pitch driver, the yaw bearing 10, the yaw driver, the main bearing 6a, and a generator bearing, respectively.

In addition, two lubricant supply and recovery devices 20 are installed to supply the lubricant to the hub 8 that controls the pitch bearing 9a and the pitch driver, and four lubricant supply and recovery devices 20 are installed to supply lubricant to the nacelle 3 that controls the yaw bearing 10, the yaw driver, the main bearing 6a, and a power generation bearing. Since all of the lubricant supply and recovery devices 20 are installed in a narrow space, a worker must carry out a repair and fix work in a narrow space within a predetermined time.

In addition, the lubricant is filled in the pump assembly 21 provided, in the lubricant supply and recovery devices 20, and consumed in different amounts according to capacities of the wind generators. According to occasions, the lubricant supply and recovery devices 20 must be replaced with one suitable for the capacity of the pump assembly 21.

In addition, a marine wind power among wind powers may foe difficulty repaired and maintained due to the installation locations thereof, and thus one emergency lubricant supplying device is additionally installed for each part. Accordingly, if the lubricant supplying device of each part is failed, the emergency lubricant supplying device is set to immediately operate, so that the installation costs of the wind generator are increased.

### DISCLOSURE

### [Technical Problem]

The present invention is made in order to solve the above problem, and an object of the present invention is to reduce two types of lubricant supplying devices applied to a pitch bearing and a pitch driver, respectively, to one lubricant supplying device, and to reduce two types of lubricant supplying devices applied to a yaw bearing and a yaw driver, respectively, to one lubricant supplying device, so that the installation space can be significantly reduced.

Another object of the present invention is to provide a lubricant supply and recovery apparatus having a pump assembly in which replaceable lubricant cartridges having different lubricant capacities can be employed corresponding to the capacity of a wind generator.

A still another object of the present invention is to provide a recovery apparatus, which can recover a lubricant returned from a pitch bearing or a yaw bearing along an orbit while supplying the lubricant to the pitch bearing or the yaw bearing, in the form of a system.

A still another object of the present invention is to provide one lubricant supplying apparatus of a marine wind generator to function as a main lubricant supplying device and an emergency lubricant supplying device.

### [Technical Solution]

In order to accomplish the above objects, according to the present invention, there is provided a lubricant supplying apparatus (100) including a bearing pump unit (110) filled with a lubricant for a pitching bearing or a yaw bearing, a driver pump unit (120) filled with a lubricant for a pitch driver or a yaw driver, a driving part housing (130) to receive a motor (131) and a cam (132) mounted on a shaft of the motor, a supply pump unit (140) asymmetrically coupled to the cam (132) to be driven, a bearing supply line (150) provided under the bearing pump unit (110) to fill the lubricant pumped by the supply pump unit (140) into the bearing pump unit (110) and to supply the lubricant filled in the bearing pump unit (110) to the pitch bearing or the yaw bearing, a driver supply line (160) provided under the driver pump unit (120) to fill the lubricant pumped by the supply pump unit (140) into the driver pump unit (120) and to supply the lubricant filled in the driver pump unit (120) to the pitch driver or the yaw driver, and a controller (170) provided on the driving part housing (130) to control the lubricant supplying apparatus (100).

In addition, according to the present invention, there is provided a lubricant supply and recovery apparatus (200) including a bearing pump unit (210) filled with a lubricant for a pitch bearing or a yaw bearing, a recovery pump unit (220) to recover the lubricant, which is transferred along an orbit, from the pitch bearing or the yaw bearing, a driver part, housing (230) to receive a motor (231) and a cam coupled to a shaft of the motor, a supply pump unit (240) asymmetrically coupled to the cam to be driven, a bearing supply line (250) provided under the bearing pump unit (210) to fill the lubricant pumped by the supply pump unit (240) into the bearing pump unit (210) and to supply the lubricant filled in the bearing pump unit (210) to the pitch hearing or the yaw bearing, a bearing recovery line (260) provided under the recovery pump unit (220) to recover the lubricant pumped by the supply pump unit (240) to the recovery pump unit (220), and a controller (270) provided or, the driving part, housing (230) to control the lubricant supply and recovery apparatus (200).

### [Advantageous Effects]

As described above, according to the present invention, the lubricant supplying apparatuses, which supply the lubricant to the pitch bearing and the pitch driver, are reduced to one lubricant supplying apparatus and provided in the rotor provided at an upper portion of the wind generator. Accordingly, differently from the related art, the problem that the total two lubricant supplying apparatuses for the pitching bearing and the pitch driver, respectively, are inconveniently installed can be overcome.

In addition, the lubricant supplying apparatus provided at an upper end of the main tower of the wind generator to supply the lubricant to the yaw bearing and the yaw driver is reduced to one lubricant supplying apparatus. Accordingly, differently from, the related art, the problem that the total two lubricant supplying apparatuses for the yaw bearing and the yaw driver, respectively, are inconveniently installed can be overcome.

In addition, the lubricant supplying apparatus, which supply the lubricant to the main bearing and the generator bearing, are reduced to one lubricant supplying apparatus. Accordingly, differently from the related art, the problem that two of the main bearing and the generator bearing are inconveniently installed can be overcome.

Therefore, according to the present invention, one lubricant, supplying apparatus is installed for a rotor, and two lubricant supplying apparatuses are installed to the nacelle. Accordingly, when, repair and fixing works are regularly performed, the working space for the repair and fixing works can be ensured. Accordingly, the work efficiency can be improved.

### DESCRIPTION OF DRAWINGS

FIG. 1 is a half-cut sectional view showing a nacelle and a rotor provided at an upper portion of a wind generator according to the present invention.

FIG. 2 is a perspective view showing a lubricant supply and recovery apparatus applied to the wind generator according to the present invention.

FIG. 3 is a view showing a pumping part applied to the wind generator according to the present invention.

FIG. 4 is a view showing the whole structure of a lubricant supplying apparatus according to the present invention.

FIG. 5 is a circuit diagram showing the lubricant supplying apparatus according to the present invention.

FIG. 6 is an enlarged view schematically showing a cartridge employed in a bearing pump unit according to the present invention.

FIG. 7 is a circuit, diagram showing the operation of the lubricant supplying apparatus according to the present invention.

FIG. 8 is a circuit diagram showing a lubricant supply and recovery apparatus According to another embodiment of the present invention.

FIG. 9 is an enlarged view schematically showing the cartridge employed in the bearing pump unit according to another embodiment of the present invention.

FIG. 10 is a circuit diagram showing the operation of the lubricant supply and recovery apparatus according to another embodiment of the present invention.

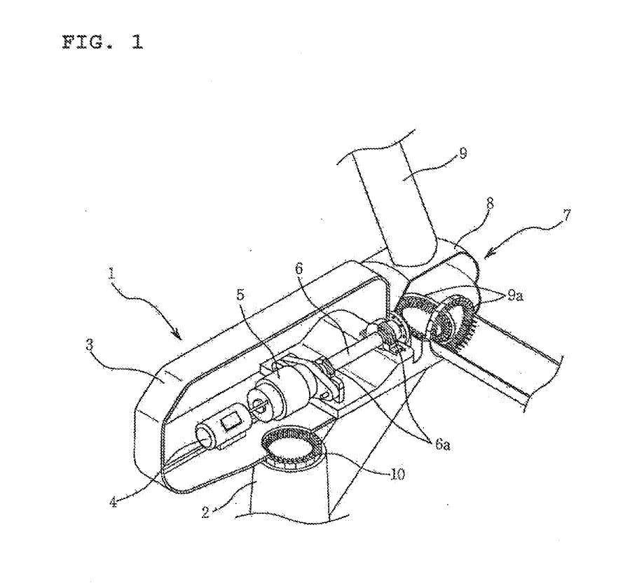

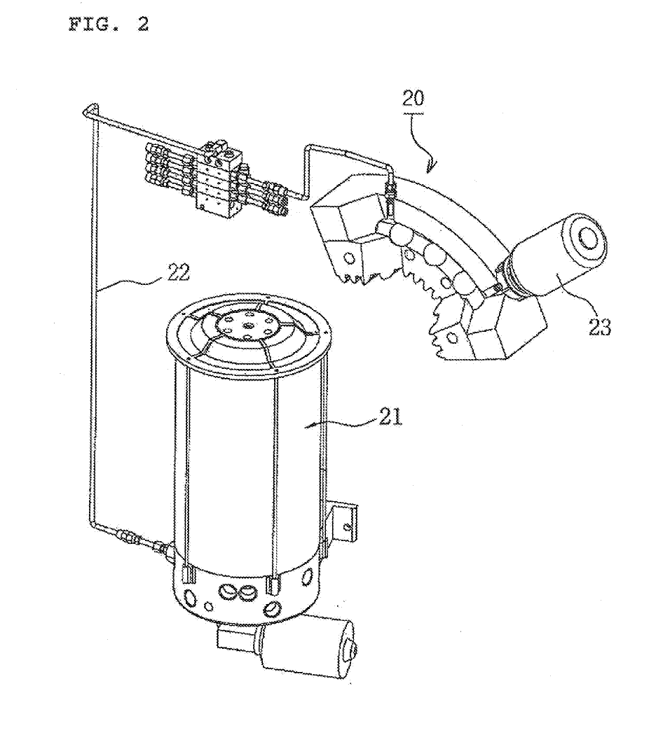

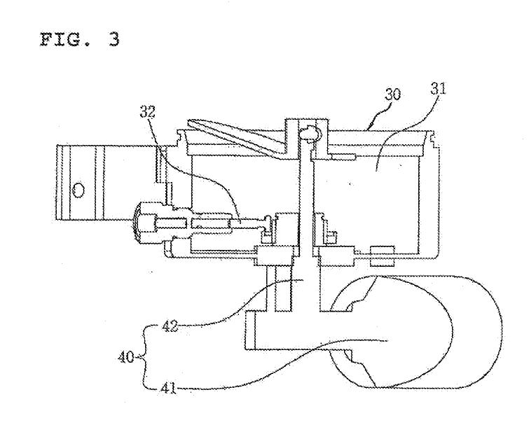

### BEST MODE

### [Mode for Invention]

Hereinafter, the present invention will be described in detail with reference to accompanying drawings.

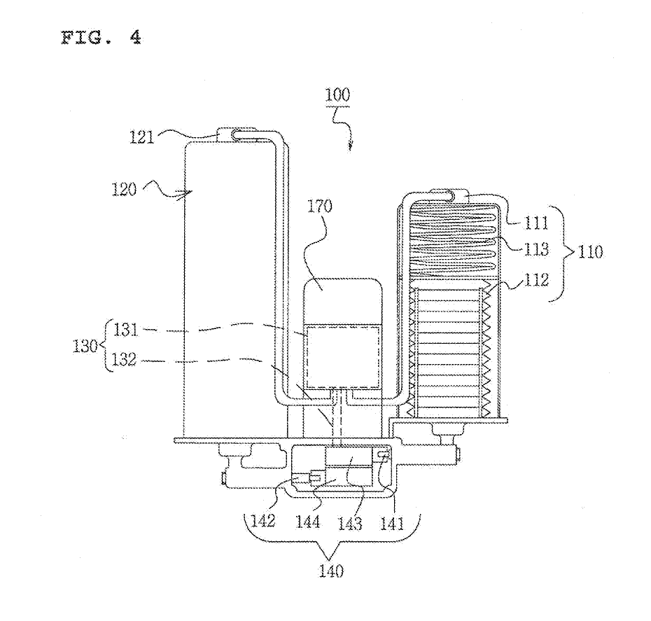

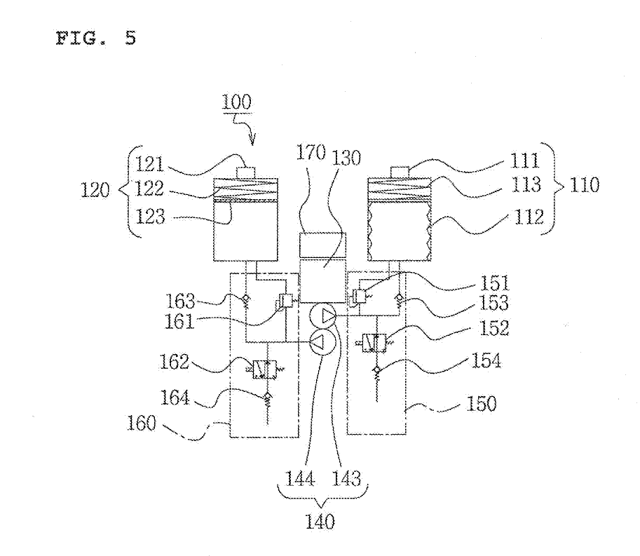

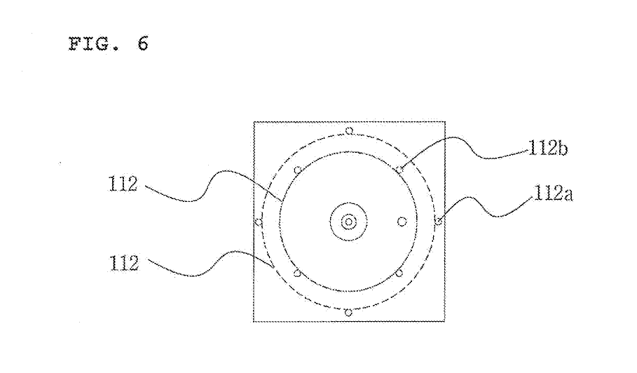

As shown in FIGS. 4 to 6, a lubricant supplying apparatus 100 includes a bearing pump unit 110 filled with a lubricant for a pitching bearing or a yaw bearing;

a driver pump unit 120 filled with a lubricant for a pitch driver or a yaw driver;

a driving part housing 130 to receive a motor 131 and a cam 132 mounted on a shaft of the motor; a supply pump unit 140 asymmetrically coupled to the cam 132 to be driven, a bearing supply line 150 provided under the bearing pump unit 110 to fill the lubricant pumped by the supply pump unit 140 into the bearing pump unit 110 and to supply the lubricant filled in the bearing pump unit 110 to a pitch, bearing or a yaw bearing,

a driver supply line ISO provided under the driver pump unit 120 to fill the lubricant pumped by the supply pump unit 140 into the driver pump unit 120 and to supply the lubricant filled in the driver pump unit 120 to the pitch driver or the yaw driver, and a controller 170 provided on the driving part housing 130 to control the lubricant supplying apparatus 100.

In addition, a lubricant supply and recovery apparatus 200 according to the present invention includes a bearing pump unit 210 filled with a lubricant for a pitch bearing or a yaw bearing, a recovery pump unit 220 to recover the lubricant, which is transferred along an orbit, from the pitch bearing or the yaw bearing, a driver part housing 230 to receive a motor 231 and a cam (not shown) coupled to a shaft. of the motor 231, a supply pump unit 240 asymmetrically coupled to the cam to be driven, a bearing supply line 250 provided under the bearing pump unit 210 to fill the lubricant pumped by the supply pump unit 240 into the bearing pump unit 210 and to supply the lubricant filled in the bearing pump unit 210 to the pitch bearing or the yaw bearing, a bearing recovery line 260 provided under the recovery pump unit 220 to recover the lubricant pumped by the supply pump unit 240 to the recovery pump unit 220, and a controller 270 provided on the driving part housing 230 to control, the lubricant supply and recovery apparatus 200.

In addition, a capacity sensing sensor 111 is provided at an outside of the bearing pump unit 110 to detect a filling capacity of the lubricant filled in the bearing pump unit 110, a lubricant cartridge 112 is provided at a lower inner portion of the bearing pump unit 110 and easily detachably attached to the wind generator according to a capacity to receive the lubricant, and an elastic member 113 is provided on the lubricant cartridge 112 to ascend or descend according to the capacity of the lubricant.

In this case, the bearing pump unit 110 may include a large hold 112a and a small hold 112b to hold an outer appearance of the lubricant cartridge 112 having a size varied depending on the capacity of the lubricant.

A capacitor sensing sensor 121 is provided at an outside of the driver pump unit (120) to detect a filling capacity of the lubricant filled in the driver pump unit 120, and an elastic member 123 is provided on a plate 122 provided at an inside of the driver pump unit 120 to ascend or descend according to the capacity of the filled lubricant.

In addition, the supply pump unit 140 includes a bearing pump 143 having an upper piston 141 and a driver pump 144 having a lower piston 142.

The bearing supply line 150 includes a relief valve 151 to be open or closed such that the lubricant pumped by the bearing pump 143 is transferred to the bearing pump unit 110, a check valve 153 to transfer the lubricant filled in the bearing pump unit 110 only to a solenoid valve 152, and a check valve 154 to supply a lubricant, which is discharged as the solenoid valve 152 is open, toward the pitch bearing or the yaw bearing.

In addition, the driver supply line 160 includes a relief valve 161 to be open or closed such that, the lubricant pumped by the driver pump 144 is transferred to the driver pump unit 120, a check valve 163 to transfer the lubricant filled in the driver pump unit 120 only to a solenoid valve 162, and a check valve 164 to supply a lubricant, which is discharged as the solenoid valve 162 is open, toward the pitch driver or the yaw driver.

Further, a capacity sensing sensor 211 is provided at an outside of the bearing pump unit 210 to detect a filling capacity of the lubricant filled in the bearing pump unit 210, a lubricant cartridge 212 is provided at a lower inner portion of the bearing pump unit 210 and easily detachably attached to the wind generator according to a capacity to receive the lubricant, and an elastic member 213 is provided on the lubricant cartridge 212 to ascend or descend according to the capacity of the lubricant.

In this case, the bearing pump unit 210 may include a large hold 212a and a small hold 212b to hold an outer appearance of the lubricant cartridge 212 having a size varied depending on the capacity of the lubricant.

In addition, the recovery pump unit 220 includes a capacity sensing sensor 221 provided at an outer portion thereof to detect the capacity of the recovered lubricant and a recovery tub 222 to store the recovered lubricant.

In addition, the supply pump unit 240 includes an upper bearing pump 243 and a lower recovery pump 244.

Further, the bearing supply line 250 includes a relief valve 251 to be open or closed such that the lubricant pumped by the bearing pump 243 is transferred to the bearing pump unit 210, a check valve 253 to transfer the lubricant filled in the bearing pump unit 210 only to a solenoid valve 252, and a check valve 254 to supply a lubricant, which is discharged as the solenoid valve 252 is open, toward the pitch bearing or the yaw bearing.

The bearing recovery line 260 includes a check valve 261 to transfer a waste lubricant, which is recovered through the pumping of the lower recovery pump 244, only to the recovery pump unit 220.

Hereinafter, the operation of the present invention having the above configuration will be described.

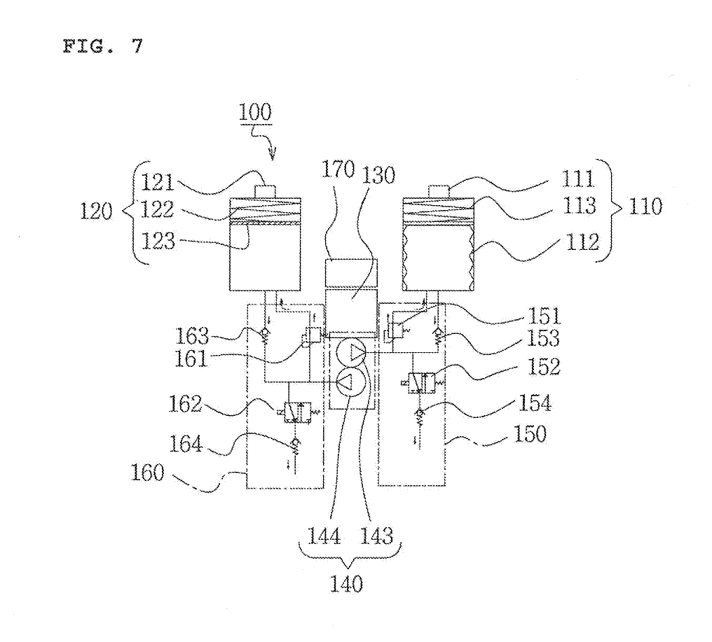

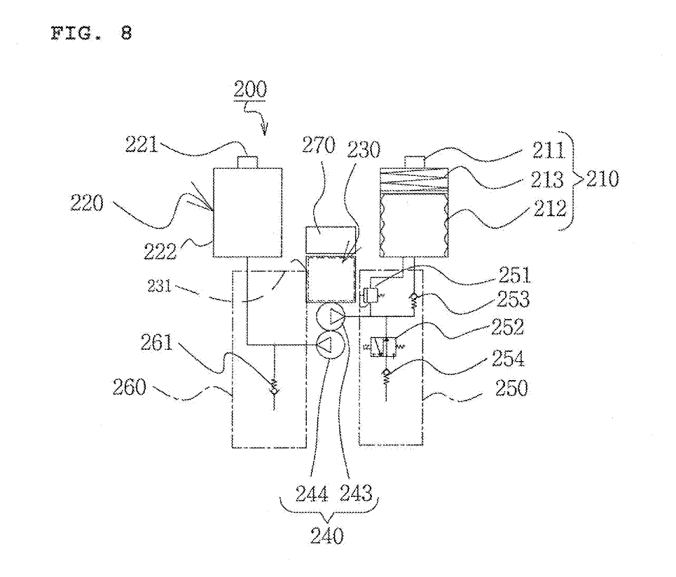

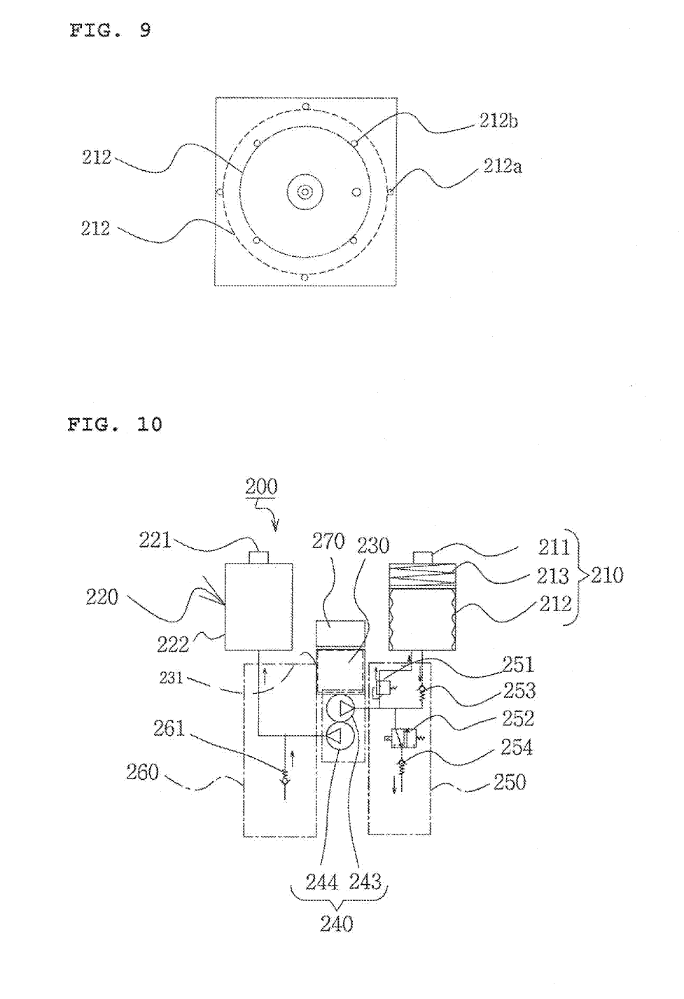

As shown in FIG. 7, the operation of the lubricant supplying apparatus 100 for the bearing according to the present invention is operated under the control of the controller 170. First, if the motor 131 provided in the driver part housing 130 is driven so that the cam 132 mounted on the shaft is driven, the bearing pump 143 and the driver pump 144 coupled to the cam 132 are simultaneously operated. In this case, the bearing pump 143 and the driver pump 144 are asymmetrically coupled to the cam 132, so that the bearing pump 143 having the upper piston 141 and the driver pump 144 having the lower piston 142 are asymmetrically operated.

Regarding the supply of the lubricant to the pitch bearing or the yaw bearing by the pumping of the bearing pump 143, as the bearing pump 143 and the driver pump 144 are simultaneously operated, the piston 141 of the bearing pump 143 is repeatedly moved back and forth, so that the pumped lubricant is transferred to the open relief valve 151, and introduced into the cartridge 112 of the bearing pump unit 110. The lubricant introduced into the cartridge 112 is discharged from the cartridge 112 and transferred along the check valve 153. Then, the lubricant passes through the solenoid valve 152, and finally passes through the check valve 154, so that the lubricant is supplied to the pitch bearing or the yaw bearing.

Meanwhile, regarding the supply of the lubricant to the pitch driver or the yaw driver through the pumping of the driver pump 144, as the piston 142 of the driver pump 144 is repeatedly moved back and forth, the pumped lubricant is transferred to the open relief valve 161 and introduced into the driver pump unit 120. The lubricant introduced into the driver pump unit 120 is discharged from the driver pump unit 120 and transferred along the check valve 163. Then, the lubricant passes through the solenoid valve 162, which is open, and finally passes through the check valve, so that the lubricant is supplied to the pitch driver or the yaw driver.

If the lubricant filled into the bearing pump unit 110 and the driver pump unit 120 are supplied to the pitch bearing, the yaw bearing, the pitch driver, and the yaw driver, respectively, and used up within a predetermined time, the capacity sensing sensors 111 and 121, which are provided in the bearing pump unit 110 and the driver pump unit 120, detect the use-up of the lubricant, and the bearing pump 143 and the driver pump 144 are operated, so that the lubricant is supplied in the above-described manner.

Meanwhile, the lubricant supplying apparatus 100, which supplies the lubricant to the pitch bearing or the yaw bearing and recovers the supplied lubricant from the pitch bearing or the. yaw bearing, is operated under the control of the controller 270 as shown, in FIG. 10. First, the motor 231 provided in the driver part housing 230 is driven, and the cam mounted on the shaft is driven. In this case, the bearing pump 243 and the recovery pump 244 coupled to the cam are simultaneously operated. In this case, the operations of the bearing pump 243 and the recovery pump 244 are asymmetrically operated.

Meanwhile, regarding the supply of the lubricant to the pitch bearing or the yaw bearing through the pumping of the bearing pump 243, as the bearing pump 243 and the recovery pump 244 are simultaneously operated, the lubricant pumped by the bearing pump 243 is transferred to the open relieve valve 251 and introduced into the cartridge 212 of the bearing pump unit 210. The lubricant introduced into the cartridge 212 is discharged from the cartridge 212 and transferred along the check valve 253. Then, the lubricant passes through the solenoid valve 252, and finally passes through the check valve 254, so that the lubricant is supplied to the pitch bearing or the yaw bearing.

Meanwhile, the waste lubricant returned from the pitch bearing or the yaw bearing, which has been supplied with the lubricant, is recovered to the recovery pump unit 220 through the operation of the recovery pump 244. If the recovery pump 244 is operated, the lubricant is recovered to the recover pump unit 220 through the check valve 261.

Although the exemplary embodiments of the present invention have been described, it is understood that the present invention should not be limited to these exemplary embodiments.

In addition, it is understood by those skilled in the art that various changes and modifications can be made in the art without departing from the technical, scope of the present invention.

Accordingly, all appropriate changes, modifications, and equivalents are regarded as being within the scope and the spirit of the present invention.

### BRIEF DESCRIPTION OF REFERENCE NUMERALS

100: Lubricant supplying apparatus
110: Bearing pump unit
120: Driver pump unit
130: Driver part housing
140: Supply pump unit
150: Bearing supply line
160: Driver supply line
170: Controller
200: Lubricant supply and recovery apparatus
210: Bearing pump unit
220: Recovery pump unit
230: Driver part housing
240: Supply pump unit
250: Bearing supply line
260: Bearing recovery line
270: Controller

1. An apparatus for simultaneously supplying heterogeneous lubricants applied to all bearings and all drivers of a wind generator, the apparatus comprising a lubricant supplying apparatus (100),
wherein the lubricant supplying apparatus (100) comprises:
a bearing pump unit (110) filled with a lubricant for a pitching bearing or a yaw hearing;
a driver pump unit (120) filled with a lubricant for a pitch driver or a yaw driver;
a driving part housing (130) to receive a motor (131) and a cam (132) mounted on a shaft of the motor;
a supply pump unit (140) asymmetrically coupled to the cam (132) to be driven;
a bearing supply line (160) provided under the bearing pump unit (110) to fill the lubricant pumped by the supply pump unit (140) into the bearing pump unit (110) and to supply the lubricant filled in the bearing pump unit (110) to the pitch bearing or the yaw bearing;
a driver supply line (160) provided under the driver pump unit (120) to fill the lubricant pumped by the supply pump unit (140) into the driver pump unit (120) and to supply the lubricant filled in the driver pump unit (120) to the pitch driver or the yaw driver; and
a controller (170) provided on the driving part housing (130) to control the lubricant supplying apparatus (100).

2. The apparatus of claim 1, further comprising:
a capacity sensing sensor (1115 provided at an outside of the bearing pump unit (110) to detect a filling capacity of the lubricant filled in the bearing pump unit (110);
a lubricant cartridge (112) provided at a lower inner portion of the bearing pump unit (110) and easily detachably attached to the wind generator according to a capacity to receive the lubricant; and
an elastic member (113) provided on the lubricant cartridge (112) to ascend or descend according to the capacity of the lubricant.

3. The apparatus of claim 1, wherein the bearing pump unit (110) comprises a large hold (112a) and a small hold (112b) to hold an outer circumferential part of the lubricant cartridge (112) corresponding to a size of the lubricant cartridge (112), which is varied depending on the capacity of the lubricant.

4. The apparatus of claim 1, further comprising: a capacitor sensing sensor (121) provided at an outside of the driver pump unit (120) to detect a filling capacity of the lubricant filled in the driver pump unit (120); and
an elastic member (123) provided on a plate (122) provided at an inside of the driver pump unit (120) to ascend or descend according to the capacity of the filled lubricant.

5. The apparatus of claim 1, wherein the supply pump unit (140) comprises a bearing pump (143) having an upper piston (141) and a driver pump (144) having a lower piston (142).

6. The apparatus of claim 1, wherein the bearing supply line (150) comprises: a relief valve (151) to be open or closed such that the lubricant pumped by the bearing pump (143) is transferred to the bearing pump unit (110);
a check valve (153) to transfer the lubricant filled in the bearing pump unit (110) only to a solenoid valve (152); and
a check valve (154) to supply a lubricant, which is discharged as the solenoid valve (132) is open, toward the pitch bearing or the yaw bearing.

7. The apparatus of claim 1, wherein the driver supply-line (160) comprises; a relief valve (161) to be open or closed such that the lubricant pumped by the driver pump (144) is transferred to the driver pump unit (120);
a check valve (163) to transfer the lubricant filled in the driver pump unit (120) only to a solenoid valve (162); and
a check valve (164) to supply a lubricant, which is discharged as the solenoid valve (162) is open, toward the pitch driver or the yaw driver.

8. A lubricant supply and recovery apparatus for all bearings of a wind generator, wherein the lubricant supply and recovery apparatus (200) comprising:
a bearing pump unit (210) filled with a lubricant for a pitch bearing or a yaw bearing;
a recovery pump unit (220) to recover the lubricant, which is transferred along an orbit, from the pitch bearing or the yaw bearing;
a driver part housing (230) to receive a motor (231) and a cam coupled to a shaft of the motor;
a supply pump unit (240) asymmetrically coupled to the cam to be driven;
a bearing supply line (250) provided under the bearing pump unit (210) to fill the lubricant pumped by the supply pump unit (240) into the bearing pump unit (210) and to supply the lubricant filled in the bearing pump unit (210) to the pitch bearing or the yaw bearing;
a bearing recovery line (260) provided under the recovery pump unit (220) to recover the lubricant pumped by the supply pump unit (240) to the recovery pump unit (220); and
a controller (270) provided on the driving part housing (230) to control the lubricant supply and recovery apparatus (200).

9. The lubricant supply and recovery apparatus of claim 8, further comprising:
a capacity sensing sensor (211) provided at an outside of the bearing pump unit (210) to detect a filling capacity of the lubricant filled in the bearing pump unit (210);
a lubricant cartridge (212) provided at a lower inner portion of the bearing pump unit (210) and easily detachably attached to the wind generator according to a capacity to receive the lubricant; and
an elastic member (213) provided on the lubricant cartridge (212) to ascend or descend according to the capacity of the lubricant received in the lubricant cartridge (212).

10. The lubricant supply and recovery apparatus of claim 8, wherein the recovery pump unit (220) includes a capacity sensing sensor (221) provided at an outer portion, thereof to detect the capacity of the recovered lubricant and a recovery tub (222) to store the recovered lubricant.

11. The lubricant supply and recovery apparatus of claim 8, wherein the supply pump unit (240) comprises an upper bearing pump (243) and a lower recovery pump (244).

12. The apparatus of claim 8, wherein the bearing supply line (250) comprises:
a relief valve (251) to be open or closed such that the lubricant pumped by the bearing pump (243) is transferred to the bearing pump unit (210);
a check valve (253) to transfer the lubricant filled in the bearing pump unit (210) only to a solenoid valve (252); and
a check valve (254) to supply a lubricant, which is discharged as the solenoid valve (252) is open, toward the pitch bearing or the yaw bearing.

13. The lubricant supply and recovery apparatus of claim 8, wherein the bearing recovery line (260) includes a check valve (261) to transfer a waste lubricant, which is recovered through the pumping of the lower recovery pump (244), only to the recovery pump unit (220).
